(19) United States
(12) Patent Application Publication
(10) Pub. No.: US 2012/0158477 A1
(43) Pub. Date: Jun. 21, 2012

(54) SOCIAL INCENTIVES PLATFORM

(75) Inventors: Moshe Tennenholtz, Haifa (IL); Roy Varshavsky, Even Yehuda (IL); Ron Karidi, Herzeliya (IL); Aviv Zohar, Mountain View, CA (US); Yuval Emek, Zurich (CH); Kira Radinsky, Zichron Yaakov (IL)

(73) Assignee: Microsoft Corporation, Redmond, WA (US)

(21) Appl. No.: 12/970,968

(22) Filed: Dec. 17, 2010

(51) Int. Cl. G06Q 30/00

(52) U.S. Cl. 705/14.19

(57) ABSTRACT

A social incentive system is described herein that formalizes information propagation through social networks in a structured and systematic way. The system provides incentives and rewards to entities who participate in propagating the information, allowing heavy influencers to gain from their influence while the marketer rewards them. The system provides one or more tools for creation and design of social incentive plans with rewards for socially distributing information, including marketing campaigns. In particular, the system introduces a semantic framework where marketers can create structured incentive plans for rewarding consumers and distribution platforms for distributing information through social networks. As users complete specified activities they earn points, and the points can be redeemed for various incentives, such as cash, debit cards, prizes, merchandise, subscriptions, and so forth. The framework is robustly designed to avoid abuse and allow for fraud detection.

### BACKGROUND

Computer users today are members of a variety of social networks through which they are connected with a great many users. Computer users may have personal networks through websites such as Facebook and MySpace, professional networks through websites such as LinkedIn, as well as work related networks stored in MICROSOFT™ OUTLOOK™ contacts or other data stores. Users may also have other relationships with other users, such as a blogger that has a number of blog followers and commenters. These networks connect the user to other users and give the user a voice that is widely heard among particular communities associated with the user.

Businesses have begun to use such networks for viral marketing. Viral marketing seeks to market a product, service, or idea by placing the marketing content in the hands of influential users that will distribute the content to other users. Unlike traditional marketing that may involve such activities as blasting advertisements on television or to various websites, viral marketing is often much cheaper and more effective at reaching target demographic audiences. For example, getting a popular blogger that covers outdoor topics to cover particular outdoor gear may be more effective at selling the outdoor gear than taking out thousands of dollars' worth of advertisements. Thus, companies are very interested in leveraging users' social networks to distribute information of interest to users in the networks.

Unfortunately, using this medium today is often a hit or miss proposition filled with guesswork. Certain people have positioned themselves as experts in viral marketing, and will act as consultants to design a viral marketing campaign that may or may not ever reach the intended audience. Measuring the success and the path of propagation may also be difficult, but very desirable for the marketer. Marketers want to know which users have been influential in getting information distributed, how information flows between users, and so forth so that future campaigns can be more effectively targeted. Users do not typically want to receive information they are not interested in any more than marketers want to waste effort reaching non-interested users.

### SUMMARY

A social incentive system is described herein that formalizes information propagation through social networks in a structured and systematic way. It is often the case that marketers desire to propagate campaign information organically through the social fabric in addition to promoting their marketing message through other, mass media channels. The system provides incentives and rewards to entities who participate in propagating the information, allowing heavy influencers to gain from their influence while the marketer rewards them. The system provides one or more tools for creation and design of social incentive plans with rewards for socially distributing information, including marketing campaigns. In particular, the system introduces a semantic framework where marketers can create structured incentive plans for rewarding consumers and distribution platforms for distributing information through social networks. As users complete specified activities they earn points, and the points can be redeemed for various incentives, such as cash, debit cards, prizes, merchandise, subscriptions, and so forth. The framework is robustly designed to avoid abuse and allow for fraud detection. Thus, the system formalizes the process of creating social networking marketing campaigns and allows more effective tracking and incentives.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the social incentive system, in one embodiment.

FIG. 2 is a flow diagram that illustrates processing of the social incentive system to create an incentive plan, in one embodiment.

FIG. 3 is a flow diagram that illustrates processing of the social incentive system to monitor an ongoing campaign with incentives, in one embodiment.

FIG. 4 is a block diagram that illustrates a weighted distribution of incentives using the social incentive system, in one embodiment.

### DETAILED DESCRIPTION

A social incentive system is described herein that formalizes information propagation through social networks in a structured and systematic way. It is often the case that marketers desire to propagate campaign information organically through the social fabric in addition to promoting their marketing message through other, mass media channels. The system provides incentives and rewards to entities who participate in propagating the information, allowing heavy influencers to gain from their influence while the marketer rewards them. The social incentive system provides one or more tools for creation and design of social incentive plans with rewards for socially distributing information, including marketing campaigns. In particular, the system introduces a semantic framework where marketers can create structured incentive plans for rewarding consumers and distribution platforms for distributing information through social networks. For example, a marketer can use the system to design a plan that includes a number of types of activities and points to be received for completing each activity. As users complete the activities they earn points, and the points can be redeemed for various incentives, such as cash, debit cards, prizes, merchandise, subscriptions, and so forth.

The system tracks reputation information for consumers based on how their comments and reviews are accepted by their social circle and broader audience when applicable. For example, the system can identify influencers based on their success in promoting information to their friends, taking into account whether the friends actually take action based on that information. On the other hand, users can gain social status by others watching their reputation grow. The system understands the path of propagation of marketing content distributed by the system so that the system can distribute rewards accordingly. For example, a user that forwards content may receive a portion of the credit for any further users to which the recipient forwards the content. The framework is robustly designed to avoid abuse and allow for fraud detection. For example, the system may attempt to identify attempts to game the incentives to catch users attempting to fraudulently claim incentives they have not earned. Thus, the system formalizes the process of creating social networking based marketing campaigns and allows more effective tracking and incentives than were possible with previous systems. Similarly, the system can grant distribution rights based on reputation earned, and thus limit the abuse and spamming opportunities.

The social incentive system introduces a language and framework for marketers to create structured incentive plans for campaigns where goods are socially promoted by individual distributors that are being rewarded for their distribution services through monetary or non-monetary incentives and a reputation system. One embodiment of the social incentive system is an extension to an application marketplace providing application distribution services for applications registered on this marketplace. In an example scenario, an application owner registers an application to the marketplace store, and then chooses to activate a distribution campaign. As an example, the owner decides to allocate 5% of the application proceeds for distribution fees. The owner creates a campaign, specifying the application and the 5% margin, and chooses an incentive plan (e.g., from a pre-configured list). Upon each download of the application by user A, the incentive plan the owner chooses will pay 3% distribution incentive to the user B who has sent the recommendation to user A, and 2% to the user C who promoted the application to B. This example incentive package stops delivering incentives at two levels of propagation.

In another example scenario for movie recommendations over television, the cable operator creates campaign for distributing video on demand (VOD) movies; a consumer will be able to recommend a movie to another consumer. The consumer sends an invitation to an invitee. If the invitee accepts the VOD invitation, the recommending user receives points from the system that the user can later convert to free movies (or any other incentive).

The social incentive system also maintains a reputation for users that includes tracking and publishing a distribution success rate for each distributor (i.e., how many of his product suggestions were accepted by his friends) and a product specific recommendation-accept rate. This helps to guarantee that users do not choose to abuse the system, as it will be quickly revealed to other users. Additional methods to prevent abuse are based on a dynamically changing percentage of the incentive package based on the number of people that accepted the content from the distributor. The more people accept content from a distributor, the higher the incentive the distributor receives in the end.

In some embodiments, the social incentive system helps marketers to design appropriate incentive plans to achieve marketing goals. For example, the system may help create incentives under which a user is incentivized to distribute the recommendation with tracking back to the person who sent it to him, rather than go directly to the marketplace and getting the product while bypassing the distribution path. One such mechanism is one that takes the entire conversion budget for a specific conversion and distributes it up the distribution path with weights (e.g., ½, ¼, ⅛, 1/16, and so on) where the immediate recommender gets ½, the one before him gets ¼, and so forth. In this way, each user along the path has some incentive to maintain an unbroken and tracked chain of distribution that can be reported in detail or summary form to the marketer.

In some embodiments, the social incentive system allows marketers to select from a small set of predefined, well-studied, robust structured parametric plans upon setting up a marketing plan, and sets the parameters that are suitable for the campaign goals and budget. The system may provide a user interface (e.g., through a desktop application, website, mobile application, or other method) through which the marketer specifies the complete incentive plan, and receives estimates of the associated marketing costs.

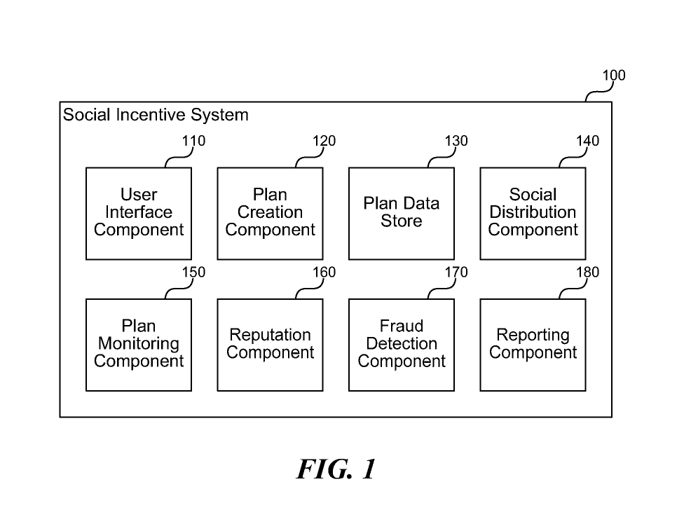

FIG. 1 is a block diagram that illustrates components of the social incentive system, in one embodiment. The system 100 includes a user interface component 110, a plan creation component 120, a plan data store 130, a social distribution component 140, a plan monitoring component 150, a reputation component 160, a fraud detection component 170, and a reporting component 180. Each of these components is described in further detail herein.

The user interface component 110 provides one or more interfaces through which distributors and marketers interact with the system to view social incentives and manage marketing plans. The user interface component 110 may provide a desktop application, web application, mobile application, programmatic application programming interface (API), web service, or other interface through which users can access the system. Marketers access the system to create a new marketing campaign or monitor existing marketing campaigns (either historical or in-progress). Distributors access the system to view earned incentives, view their reputation or that of other distributors, redeem incentive points, and so on.

The plan creation component 120 receives information from a marketer for creating a marketing plan that includes a distribution schedule for allotting social incentives to distributors that participate in marketing a product associated with the marketing plan. As used herein a product may include products, services, information, content, or other items distributed by marketers. The plan may include information such as how many levels to which incentives will propagate, a magnitude of incentive at each level, referral incentives that propagate along the path of distribution, fraud detection methods, and other information that comprises a marketing plan. The system 100 may also offer one or more predefined marketing plans that the marketer can select and/or modify to create a marketing plan for the marketer's particular product.

The plan data store 130 stores information about created marketing plans and receives requests from other components to carry out the plan. The plan data store 130 may include one or more in-memory data structures, files, file systems, hard drives, databases, storage area networks, cloud-based storage services, or other facilities for persisting data. The plan creation component 120 stores created plans in the plan data store 130, and the other components (e.g., the plan monitoring component 150) access the plan data store 130 to load plan information to carry out the plan. For example, as distributors perform desired activities the plan monitoring component 150 may access the plan data store 130 to determine an incentive to provide to a distributor.

The social distribution component 140 distributes marketing content to one or more distributors in accordance with the received marketing plan. For example, the marketing plan may specify that the marketing content will be initially sent to one or more heavy influencing distributors. A distributor may be considered heavy influencing based on past success rate at getting other users to download or view content, past earned incentives, reputation with the system 100, and so on. The marketer may also manually specify one or more heavy influencing users to which to seed the marketing campaign. The social distribution component 140 manages distribution and tracks a route of distribution from one distributor to another so that any incentives specified by the plan can be assessed and provided to the appropriate users.

The plan monitoring component 150 monitors marketing plans that are in progress of being distributed to users. The monitoring may include tracking which users have distributed the marketing content, how many users have seen the marketing content, which users have earned particular incentives, how many marketing dollars have been spent, how much of a product has been purchased, and so forth. The plan monitoring component 150 gathers data about marketing plans used by the reporting component 180 and reputation component 160.

The reputation component 160 captures and publishes information related to distributor reputation. The information may include number of distributions or invitations to view content, number of acceptances of attempts to distribute, conversion rates of referred users, and so on. Reputation information may also include negative reputation factors, such as attempts at fraud or other detected suspicious activity. The reputation component 160 gathers reputation information and publishes the information so that other users, such as marketers or other distributors, can view a particular distributor's reputation to determine whether they want to work with the distributor or make other decisions. The reputation component 160 may create a summary of all of the captured reputation information, such as a numeric score, to quantify a user's reputation.

The fraud detection component 170 detects fraudulent activity related to marketing plans. Fraudulent activity may include falsifying invitations so that it appears that a distributor has more widely distributed marketing content than is in fact true, using false email addresses, impersonating other users, complaints of spam by the user, or any other activity that is contrary to the purpose of the social incentive system 100. The fraud detection component 170 may take remediation actions such as banning a user, reducing the user's reputation score, limiting how many user's a distributor can send invitations to per period, limiting which user's a distributor can send invitations to (e.g., only friends), and so forth.

The reporting component 180 accesses the plan data store 130 and provides information to marketers about ongoing or completed marketing plans. The reports may allow the marketer to determine how effective a particular marketing campaign has been, which users have been most influential, how marketing dollars are being used, and so forth. The reporting component 180 may provide reports via a web page, email, or other output viewable by a user of the system 100.

The computing device on which the social incentive system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

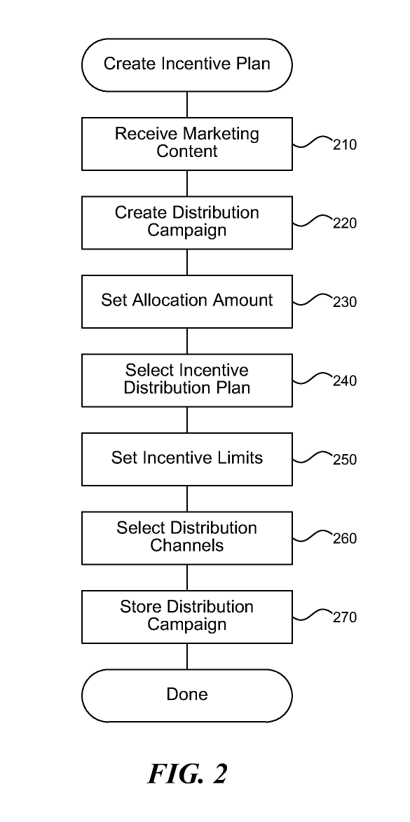

FIG. 2 is a flow diagram that illustrates processing of the social incentive system to create an incentive plan, in one embodiment. Beginning in block 210, the system receives marketing content to be distributed by one or more distributors in a marketing campaign. For example, the marketing content may be an application registered in an application marketplace (e.g., a mobile phone online store), a physical product purchased in a store by a user of the system, a movie to be downloaded through a VOD system, or other content. The system may receive the content through a web page for creating marketing campaigns, through a plug-in to an existing social network (e.g., Facebook), via email from a marketer, or through other methods.

Continuing in block 220, the system creates a distribution campaign in response to a request by a marketer associated with the received marketing content. The distribution campaign associates all of the information related to the marketing content in one place, such as incentive distribution schemes, marketing dollars allocated to distributing the content, channels for distributing the content, any time limits on the marketing campaign, and so forth.

Continuing in block 230, the system sets an allocation amount that indicates how much the marketer will spend on the created distribution campaign. The allocation amount may be specified in a currency (e.g., dollars), as a percentage of a quantity (e.g., 5% of sales), in non-monetary quantities (e.g., using incentive points from the marketer acting as a distributor for other content), and so forth. The system may receive the allocation amount from the marketer or automatically determine an amount based on defaults. Non-monetary incentives may also include virtual goods, such as badges and reputation credits. In the case of online gaming, virtual goods can be new powers or accessories for the user's virtual character.

Continuing in block 240, the system selects an incentive distribution plan that indicates one or more incentives to be given to distributors of the marketing content. The incentive plan may include hierarchical layers that establish a chain of distribution and incentives. For example, if a first user buys a product and recommends that product to a second user, then the first user may receive one point for the recommendation. If the second user recommends the product to a third user, then the second user may receive a point, and the first user may receive a point or a fraction of a point for the second user's recommendation. The first user's initial recommendation to the second user led to the third user being recommended the content, so the first user is rewarded by the incentive. In this way, those users that are very effective and serve as conduits to a large number of other users will receive high points and incentives that reward them for the influence and ability to distribute content effectively. The marketer may select the incentive distribution plan from a set of predetermined options or may create a custom incentive distribution plan tailored to the marketer's goals.

Continuing in block 250, the system sets any incentive limits. For example, the system may receive limits from the marketer that determine how many levels deep in a chain of distributors a marketing incentive will be awarded, how many marketing dollars can be spent, how many invitations a single user can send, how much incentive value a single distributor can receive, or any other limits provided by the system and selected by the marketer.

Continuing in block 260, the system selects one or more initial distribution channels for marketing the submitted content. For example, the marketer may choose to initially seed the marketing content to one or more highly influential distributors and may even provide an incentive to those users for initial distribution of the submitted content within those users' social networks. The system may also allow the marketer to buy space to advertise the content or place the content on a blog or other publicly viewable space accessible by the system.

Continuing in block 270, the system stores the distribution campaign and incentive distribution plan in a data store and starts the campaign. The system may store all of the information gathered in the previous steps in a data store, such as a database, that is accessed by components of the system throughout the duration of the marketing campaign to enforce and carry out the scope selected for the marketing campaign. After block 270, these steps conclude.

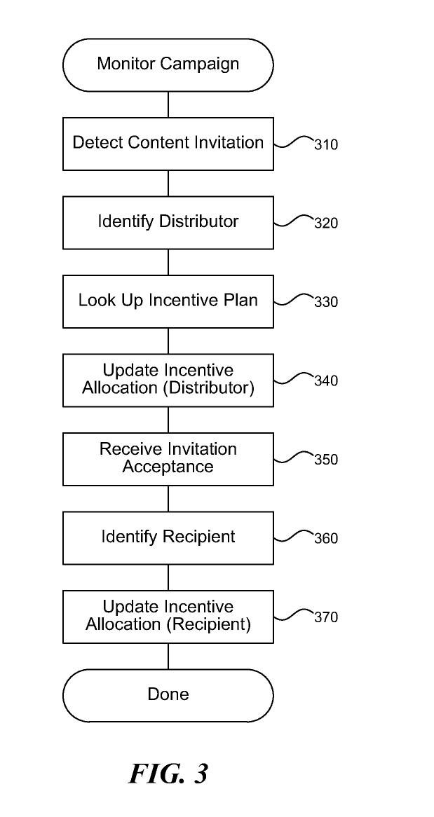

FIG. 3 is a flow diagram that illustrates processing of the social incentive system to monitor an ongoing campaign with incentives, in one embodiment. Beginning in block 310, the system detects a content invitation sent from a distributor to a recipient that invites the recipient to consume a content item. The content item may include a product, service, digital download, informational display, or any other consumable content. The system may handle invitations between users such that the system receives notification upon one user inviting another user to purchase the content item. Consuming the content item may include inviting the recipient to purchase the content item, viewing a free content item (e.g., where the marketer seeks impressions rather than purchases), or other interaction with the content item requested by the marketer.

Continuing in block 320, the system determines an identity of the distributor and accesses a profile of the distributor. The system may store information about distributors using the system in a profile that contains information about invitations sent by the distributor, accepted invitations, contact information, a reputation of the distributor, and so on. Continuing in block 330, the system looks up an incentive plan associated with the invitation that specifies how one or more incentives are determined for inviting users to purchase the content item. The invitation may identify a marketing campaign with which the invitation is associated and the system stores information about the marketing campaign, including the incentive plan configured earlier by a marketer of the content item (see FIG. 2).

Continuing in block 340, the system updates an incentive allocation associated with the determined identity of the distributor based on the incentive plan. For example, the incentive plan may specify a number of points, dollars, or other units to which the distributor is entitled for inviting another user to purchase the content item. The distributor's profile tracks the incentives received by the distributor and allows the distributor to accumulate units that can be traded for monetary incentives, products, or other incentives or prizes.

Continuing in block 350, the system receives an indication that the recipient accepted the invitation. For example, the acceptance may come in the form of the recipient purchasing the recommended content item, viewing the content item, accessing a web page for purchasing the content item, or other criteria set by the marketer that indicate a successful referral of the content item to the recipient. Continuing in block 360, the system determines an identity of the recipient and accesses a profile of the recipient. If the recipient does not have a profile, then the system may invite the recipient to create one and walk the recipient through a process for doing so. The recipient may also receive incentives and may further distribute the content to other users. The recipient's profile tracks incentives received by the recipient.

Continuing in block 370, the system updates an incentive allocation associated with the determined identity of the recipient based on the incentive plan. For example, the incentive plan may specify a number of points, dollars, or other units to which the recipient is entitled for accepting the invitation. The recipient's profile tracks the incentives received by the recipient and allows the recipient to accumulate units that can be traded for monetary incentives, products, or other incentives or prizes. The system may also update the allocation associated with the distributor once the invitation is accepted. The system may provide the distributor a higher incentive for accepted invitations as a means of reducing fraud by only rewarding the distributor (or rewarding the distributor more) upon successful distributions. After block 370, these steps conclude.

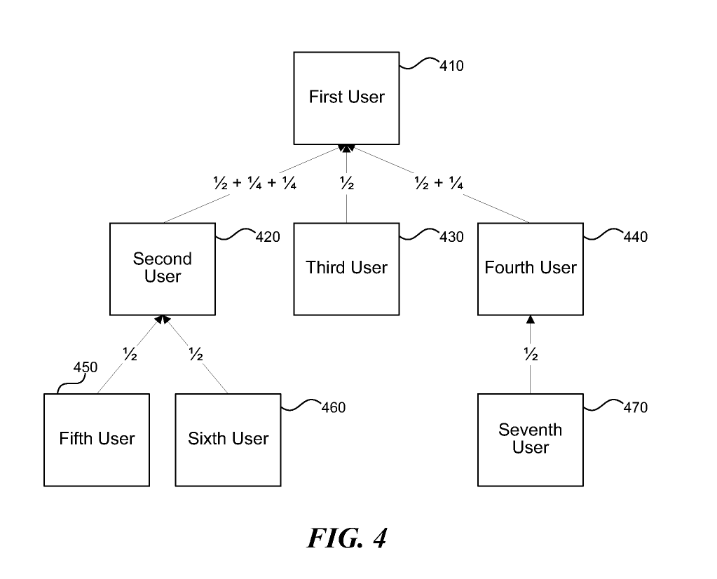

FIG. 4 is a block diagram that illustrates a weighted distribution of incentives using the social incentive system, in one embodiment. A first user 410 has a social network of many friends. Of these friends, three friends (second user 420, third user 430, and fourth user 440) completed steps specified in a marketing plan for the first user 410 to receive an incentive. Because of each of the three friends' actions, the first user 410 receives a ½ point weighted incentive from each user. Moreover, second user 420 refers content associated with the marketing plan to a firth user 450 and sixth user 460 who each completed steps specified in the marketing plan for the second user 420 to receive an incentive. Therefore, second user 420 also receives a ½ point weighted incentive from each user. I

In addition, this particular marketing plan allows incentives to propagate along the distribution chain at a decaying value, so first user 410 receives a ¼ point weighted incentive because of fifth user 450 and sixth user 460's actions. Likewise, fourth user 440 refers the content to seventh user 470, so fourth user 440 receives a ½ point weighted incentive, and first user 410 receives an additional ¼ point weighted incentive. As illustrated, distributors' actions to distribute content create a tree of incentives, and the marketing plan configured by the marketer determines an amount and type of incentive received at each level, as well as how incentives propagate through the tree. If a user is very influential, such as first user 410, the incentives can quickly add up to significant rewards, thus encouraging the user to further work to distribute the content.

Consumers in general are great at promoting products. A father buying his daughter a bicycle may recommend the bicycle to other parents that he knows based on his experience with the product. Similarly, a blogger may review items she has used and post information that causes other users to purchase the items. Two business owners may help each other find business and pay each other a referral fee for each client referred. These types of activities happen today without any formal specification or control of their occurrence. In addition, there is no way for marketers of products to reward users for their positive promotion of a product or request that the users work to further promote the product with their social network. The social incentive system provides a configurable, formalized specification of how users that distribute information about marketable items can receive incentives for doing so. Marketers can tailor incentive plans and spend marketing dollars to encourage more of this type of beneficial activity for selling products.

In some embodiments, the social incentive system contains some online components and some physical components. For example, distributor may purchase a physical product (e.g., a bicycle) in a brick-and-mortar store and receive a coupon or information sheet for promoting the item to the distributor's friends. If the distributor mentions the item to the distributor's friends, then the system may send an electronic or physical coupon that the friend can use to get a discount on the product. A user at one level of a distribution chain may receive coupons to give to friends, while distributors at higher levels receive points or other incentives as friends or friends of friends in the chain use the coupons to purchase products. The coupon may allow the system to track who purchased the product because of a particular recommendation (e.g., through a barcode or other information on the coupon captured at the time of sale).

In some embodiments, the social incentive system includes negotiable incentives. While incentives may be fixed by the marketer, the marketer may also allow distributors to negotiate an incentive either with the marketer or with other distributors. For example, a distributor may agree to give part of his incentive share to a friend if that friend agrees to redistribute the content or product to the friend's friends. In this way, the distributor can use his own ingenuity and strategy for encouraging further distribution of the marketable item.

In some embodiments, the social incentive system establishes distribution quotas based on a distributor's reputation to avoid spam. The system may include both hard and soft quotas. A hard quota may enforce that a distributor with a low reputation cannot continue to receive incentives until the distributor raises his reputation (e.g. by accepted referrals). A soft quota may slowly diminish or increase rewards based on a distributor's reputation. A distributor may start with a limited number of recommendations to distribute, and receive more as friends accept the earlier ones. If people are not accepting the distributor's recommendations, indicating potential spam, then this will act as a limit on how many recommendations the distributor can make.

In some embodiments, the social incentive system associates a cost with recommendations to reduce spam. For example, the system may charge a distributor for each recommendation to encourage the distributor to only send recommendations that the distributor believes will be accepted, so that the distributor will get a return that overcomes the cost. The charge can refer to real currency or go against virtual recommendation credits or other virtual currency that the system introduces and maintains. If the distributor chooses to spam his friends with product recommendations, then eventually the cost of the recommendations as no one or few friends accept will discourage the distributor from further spamming behavior.

In some embodiments, the social incentive system punishes distributors for bad or ineffective recommendations. For example, if the distributor sends recommendations that are not accepted, then the system may subtract from successful recommendations, reduce previously awarded incentives, reduce the distributor's reputation, and so forth. The system may allow some error rate threshold (e.g., 10%) of non-acceptances before taking away from the distributor's reputation or incentives.

In some embodiments, the social incentive system receives feedback from recommendation recipients about the recommendation and/or distributor that sent the recommendation. For example, a recipient may indicate that the recipient liked the recommendation even if the recipient is not accepting the invitation or buying the product. In this way, the distributor's reputation or incentives may be increased even though the recipient did not ultimately choose to purchase the product recommended (e.g., perhaps the recipient already had the product or exceeded his budget for discretionary expenses for the month). The recipient may also explicitly indicate that a recommendation is considered spam, causing the system to take negative action against the distributor.

From the foregoing, it will be appreciated that specific embodiments of the social incentive system have been described herein for purposes of illustration, but that various modifications may be made without deviating from the spirit and scope of the invention. Accordingly, the invention is not limited except as by the appended claims.

I/We claim:

1. A computer-implemented method for creating an incentive plan for distributing recommendations to members of a distributor's social networks, the method comprising:
receiving marketing content to be distributed by one or more distributors in a marketing campaign;
creating a distribution campaign in response to a request by a marketer associated with the received marketing content;
setting an allocation amount that indicates how much the marketer will spend on the created distribution campaign;
selecting an incentive distribution plan that indicates one or more incentives to be given to distributors of the marketing content;
selecting one or more initial distribution channels for marketing the submitted content; and
storing the distribution campaign and incentive distribution plan in a data store and starting the campaign,
wherein the preceding steps are performed by at least one processor.

2. The method of claim 1 wherein receiving marketing content comprises receiving a software application registered in an application marketplace.

3. The method of claim 1 wherein receiving marketing content comprises receiving the content through a web page for creating marketing campaigns.

4. The method of claim 1 wherein setting the allocation amount comprises specifying a percentage of sales of the content to allocate to the distribution campaign.

5. The method of claim 1 wherein setting the allocation amount comprises receiving the allocation amount from the marketer through a configuration user interface.

6. The method of claim 1 wherein selecting an incentive distribution plan comprises receiving hierarchical layers that establish a chain of distribution and incentives.

7. The method of claim 1 wherein selecting an incentive distribution plan comprises selecting a plan that rewards a distributor that recommends the marketing content, wherein the reward is based on a number of other users that purchase the content based on the distributor's recommendation.

8. The method of claim 1 wherein selecting an incentive distribution plan comprises the marketer selecting the incentive distribution plan from a set of predetermined plans.

9. The method of claim 1 wherein selecting an incentive distribution plan comprises the marketer creating a custom incentive distribution plan tailored to the marketer's goals.

10. The method of claim 1 further comprising setting one or more incentive limits that control how distributors are rewarded for recommending the marketing content to other users.

11. The method of claim 1 wherein selecting distribution channels comprises selecting to initially seed the marketing content to one or more influential distributors based on reputation.

12. A computer system for providing a social incentive platform, the system comprising:
a processor and memory configured to execute software instructions embodied within the following components;
a user interface component that provides one or more interfaces through which distributors and marketers interact with the system to view social incentives and manage marketing plans;
a plan creation component that receives information from a marketer for creating a marketing plan that includes a distribution schedule for allotting social incentives to distributors that participate in marketing a product associated with the marketing plan;
a plan data store that stores information describing created marketing plans and receives requests from other components to carry out the plan;
a social distribution component that distributes marketing content to one or more distributors in accordance with the received marketing plan;
a plan monitoring component that monitors marketing plans that are in progress of being distributed to users;
a reputation component that captures and publishes information related to distributor reputation; and
a fraud detection component that detects fraudulent activity related to marketing plans.

13. The system of claim 12 wherein the user interface component comprises a web application through which marketers access the system to create a new marketing campaign or monitor existing marketing campaigns.

14. The system of claim 12 wherein the user interface component comprises a mobile application through which distributors access the system to view earned incentives.

15. The system of claim 12 wherein the plan creation component is further configured to receive a limit of how many levels to which incentives will propagate along a distribution chain.

16. The system of claim 12 wherein the social distribution component is further configured to manage distribution and track a route of distribution from one distributor to another so that any incentives specified by the plan can be assessed and provided to the specified users.

17. The system of claim 12 wherein the plan monitoring component is further configured to track which users have distributed the marketing content and which users have earned particular incentives.

18. The system of claim 12 wherein the reputation component is further configured to track a number of invitations to view content sent by a distributor and a number of acceptances of attempts the invitations.

19. The system of claim 12 wherein the fraud detection component is further configured to detect and prevent a distributor from spamming other users with unwanted invitations related to a marketing item.

20. A computer-readable storage medium comprising instructions for controlling a computer system to monitor an ongoing marketing campaign that provides social incentives for recommending content items, wherein the instructions, upon execution, cause a processor to perform actions comprising:
detecting a content invitation sent from a distributor to a recipient that invites the recipient to consume a content item;
determining an identity of the distributor and accessing a profile associated with the distributor;
looking up an incentive plan associated with the invitation that specifies how one or more incentives are determined for inviting users to purchase the content item; and
updating an incentive allocation associated with the determined identity of the distributor based on the incentive plan.
